(19) United States
(12) Patent Application Publication
(10) Pub. No.: US 2024/0289643 A1
(43) Pub. Date: Aug. 29, 2024

(54) ATTRITION PREDICTING AND MITIGATING

(71) Applicant: NCR Voyix Corporation, Atlanta, GA (US)

(72) Inventors: Pragya Tripathi, Santa Clara, CA (US); Yanxin Ye, Atlanta, GA (US); Brij Hareshbhai Rokad, Atlanta, GA (US); Dharamendra Kumar, Placentia, CA (US)

(73) Assignee: NCR Voyix Corporation, Atlanta, GA (US)

(21) Appl. No.: 18/115,624

(22) Filed: Feb. 28, 2023

(51) Int. Cl. G06N 5/022

(52) U.S. Cl. CPC G06N 5/022

(57) ABSTRACT

An enterprise's data source relevant to their customers is obtained at predefined intervals of time. The data is processed through classification machine learning models (MLMs) and labeled with features. The labeled data is provided as input to an attrition predicting MLM and one or more lists are provided as output identifying customers likely to leave the enterprise and customers with a high likelihood of remaining with the enterprise when provided an incentive to do so. The one or more lists are provided to enterprise interfaces and/or promotion systems for mitigating customer attrition. In an embodiment, results for the attrition predicting MLM are compared against results predicted by a Recency, Frequency, Monetary (RFM) analyzer in view of subsequent actual observed results for the customers with the enterprise. A continuous feedback loop for retaining the attrition prediction MLM is processed based on the comparison to improve the prediction MLM's F1 accuracy metric.

### BACKGROUND

Attracting new customers to an enterprise can be costly. Maximizing the relationship with existing customers and getting them to use enterprise products is faster and less costly. The relationship between the enterprise and its customer is in jeopardy; if the enterprise is unable to understand its customer's needs, then the enterprise will lose its customer to a different enterprise that is able to fulfill those needs.

### SUMMARY

In various embodiments, a system and methods for predicting customer attrition and mitigating attrition are presented. Machine learning models (MLMs) are trained to extract features from customer data, the features are labeled in the data and used to train an attrition MLM. The attrition MLM produces a first list of customers likely to leave an enterprise and a second list of customers that are likely to stay as customers of the enterprise if provided an incentive.

In an embodiment, a Recency, Frequency, Monetary (RFM) analyzer processes the data and predicts customers that are likely to leave the enterprise. Actual results from customer data are compared against results produced by the RFM analyzer and produced by the attrition MLM. The results of the comparison provide a feedback loop to continuous train the attrition MLM.

The predicted lists of the attrition MLM are provided via Application Programming Interfaces (APIs) to interfaces and systems of the enterprise. In an embodiment, the list associated with customers that are likely to stay with an incentive is provided to a promotion system of the enterprise to proactively mitigate attrition of the corresponding customers with enterprise-based promotions/incentives for customer retention. In an embodiment, the predicted lists from the attrition MLM are streamed to a dashboard interface of an enterprise's application for viewing in real time by users of the enterprise within the context of the application's user interface.

### BRIEF DESCRIPTION OF THE DRAWINGS

FIG. 1A is a diagram of a system for attrition prediction and mitigation, according to an example embodiment.

FIG. 1B is a flow diagram of a method for operating the system of FIG. 1A, according to an embodiment.

FIG. 2 is a flow diagram of a method for predicting and mitigating customer attrition, according to an example embodiment.

FIG. 3 is a flow diagram of another method for predicting and mitigating customer attrition, according to an example embodiment.

### DETAILED DESCRIPTION

As stated above, it is expensive for enterprises to acquire new customers. This is particularly true with financial institutions (FIs) where the average customer acquisition cost is over $500. If a bank loses 35,000 customers, it will cost 17.5 million dollars to acquire an equivalent number of new customers. Studies show that retaining an existing customer is 5 times less expensive than acquiring a new customer and increasing customer retention by 5% can increase profits from 25-95%. Additional research by leading consulting firms shows FIs lost 10% to 15% of gross revenues to attrition. Accordingly, FIs need to focus on maximizing customer relationships with their existing customers.

Discussed herein and below, methods and a system for predicting and mitigating customer attrition are taught. The customers likely to leave an enterprise are predicted and customers most likely to remain with the enterprise when provided an incentive are identified. The likelihood of attrition is preventable by timely identifying signals and relationships present in the customer data. Non-personal identifiable information (PII) is obtained for customers of a given enterprise to ensure the customer data is anonymized for privacy, only the enterprise can identify the true identity of any given customer from its customer data. Data features are identified for each customer's set of data using classification machine learning models (MLMs). The features are labeled in the data and used to train an attrition MLM to produce as output a first list of customers with a high likelihood of attrition and a second list of customers with a high preventable likelihood of attrition. The lists are provided to interfaces and systems of the enterprise via APIs.

Furthermore, the evaluation metrics of the attrition MLM are continuously monitored so as to improve on the accuracy of the predicted lists. For example, an RFM analyzer separately analyzes the customer data to identify customers likely to leave the enterprise. The analyzer provides a list of customers likely to leave. The predicted list of the attrition MLM is compared against the RFM list in view of subsequent observed actual results of the enterprise (i.e., customers who left the business of the enterprise, customers who were provided incentives to stay with the enterprise and did, and customers who were provided incentives to stay with the enterprise but did not). The evaluation metrics of the RFM analyzer are compared against the same evaluation metric for predicted lists of the attrition MLM in view of the actual results and used as feedback to train the attrition MLM. In this way, the attrition MLM is continuously trained to improve metrics of its predicted lists.

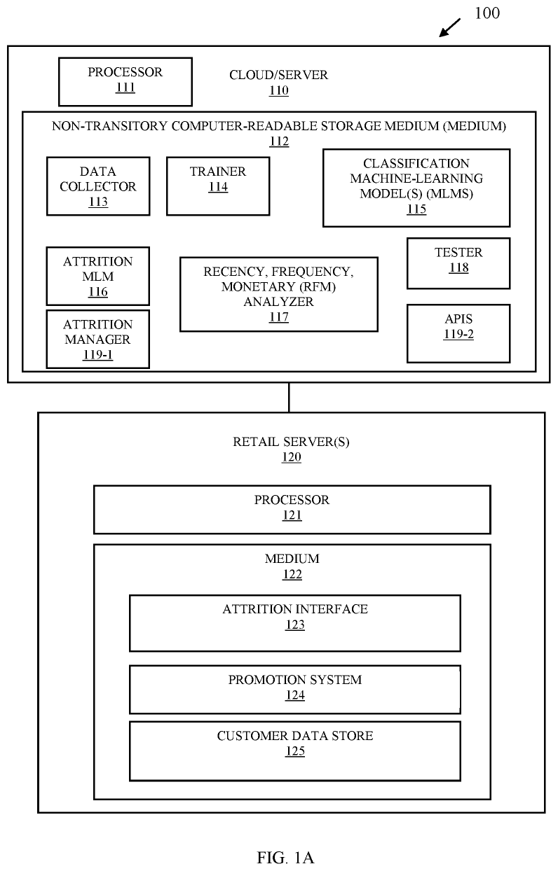

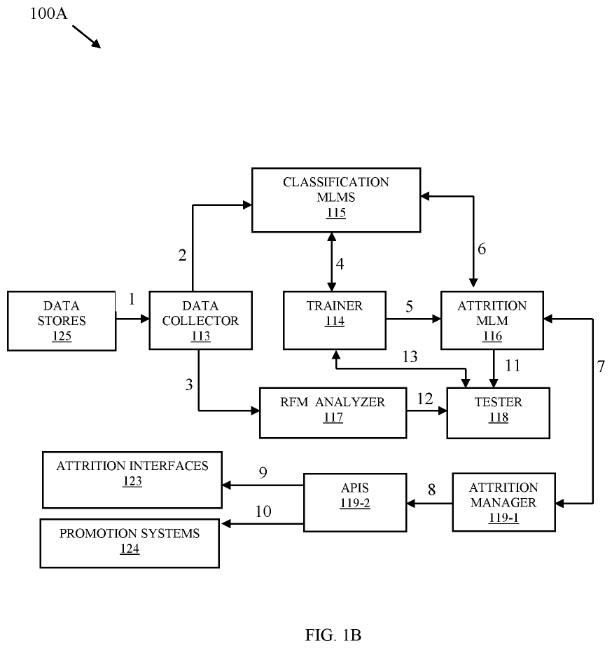

FIG. 1A is a diagram of a system 100 for predicting and mitigating customer attrition, according to an example embodiment. It is to be noted that the components are shown schematically in greatly simplified form, with only those components relevant to understanding of the embodiments being illustrated.

Furthermore, the various components (that are identified in FIG. 1A) are illustrated and the arrangement of the components is presented for purposes of illustration only. It is to be noted that other arrangements with more or less components are possible without departing from the teachings of a real-time and dynamic media optimizer for terminals presented herein and below.

System 100 is data-driven and provides a real-time and predictive lists of an enterprise's customers including a first list of customers who are likely to leave the business of the enterprise and a second list of a predictive customers who have a high likelihood of preventable departure from the enterprise (i.e., can be persuaded through incentives/promotions to stay with the enterprise). Instead of RFM analysis, only customized MLMs are processed, and their results are continuously compared against an RFM analysis and actual observed results of the enterprise with the predictive customers of the lists. A continuous feedback loop is established to improve the evaluation metrics of the MLMs based on the comparison. The predictive lists are supplied via APIs to a promotion system of the enterprise to mitigate customer departures with targeted customer promotions and/or provided to enterprise interfaces through reports or dashboards embedded within enterprise applications.

System 100 includes a cloud 110 or a server 110 (hereinafter just “cloud 110”) and a plurality of enterprise servers 120. Cloud 110 includes a processor 111 and a non-transitory computer-readable storage medium (hereinafter just “medium”) 112, which includes executable instructions for a data collector 113, an MLM trainer 114, classification MLMs 115, an attrition MLM 116, an RFM analyzer 117, a tester 118, an attrition manager 119-1, and APIs 119-2. Processor 111 obtains or is provided the executable instructions from medium 112 causing processor 111 to perform operations discussed herein and below with respect to 113-119-2.

Each retailer server 120 includes a processor 121 and a medium 122, which includes executable instructions for an attrition interface 123, a promotion system, and a customer data store, a media manager 124, and a baseline optimizer interface 125. Processor 121 obtains or is provided the executable instructions from medium 122 causing processor 121 to perform operations discussed herein and below with respect to 123-124. It is to be noted that retailer server 120 can include a variety of other systems, such as a transaction system, a maintenance and support system, a scheduling system, etc. Moreover, access to data store 125 can be through APIs or data store interfaces and applications.

Each enterprise data store 125 includes a variety of customer data and/or data tables relevant to each customer's account for account/transaction history, details about the customer known to the enterprise, customer/account identifier for the customer, promotions/incentives offered to the customer, and an active or inactive customer status along with a date that any customer became inactive. In the case where the enterprise is a FI, the details about the customer may also include factors or values the enterprise uses to assess the creditworthiness of the customer, for example an enterprise assigned high, medium, or low credit score based on an estimated credit score for the customer. A FI may also maintain details for a customer associated with marital status, current known address, transaction dates for each transaction of the customer, transaction locations for each transaction, age, employer, saving balances, loan balances, average monthly income, average monthly expenditures, etc.

A single enterprise can have several data stores relevant to a single customer, such as a transactional data store, banking activity data store, personal information data store, etc. Furthermore, a single customer can have multiple accounts with a single enterprise. For example, a banking customer of a bank can have a credit card account, a loan account, a savings account, and a checking account. A customer identifier maintained by the bank for the customer links the various accounts and data stores for the customer to a single customer.

Data collector 113 receives data over a given period of time (e.g., over the most-recent 3 months) from the data stores 125 from a given enterprise utilizing the cloud-based services of cloud 110. Individual data for the customers is segmented out based on customer identifiers maintained by the enterprise for their customers. No PII is received by collector 113, such as social security number, name, telephone number, email address, etc. In this way, the processed data about customers is anonymized, such that only the enterprise knows the true identify of their customers.

Collector 113 generates sets of data for each customer based on a same customer identifier appearing in the data. The sets are merged into a single collection of data per customer and maintained in an unprocessed data store.

The unprocessed data store is fed to multiple classification MLMs 115 as input. Each classification MLM 115 is trained to identify a single or a set of features by classifying the data in each collection of unprocessed data. One feature identified in the unprocessed data by one or more MLMs 115 includes a type of transaction along with the associated transaction details, such as transaction amount, transaction date, transaction location, payment source, entity name/identifier associated with any transaction payment, etc. The transaction type can be associated with, a loan payment, a credit card purchase, a direct deposit, a cash withdrawal, a transfer of funds between two accounts, a utility payment, an insurance payment, a new mortgage, a cell provider payment, etc. Another feature identified by one or more other MLMs 115 includes type of non-PII information such as a current home address, an estimated credit score, a marital status, age, average monthly income, average monthly expenditures, current savings balance, an enterprise assigned customer identifier, total number of accounts, total number of loans/mortgages, cars owned, houses owned, total number of late payments per loan, etc. Another feature identified by one or more other MLMs 115 includes an entity type associated with the entity identified in a transaction. The entity type can include a FI, a retailer, a health car provider, a collection agency, a private individual, a grocery store, a utility company, a content media provider, a gaming provider, etc.

The trained classification MLMs 115 can be executed in parallel with one another on the unprocessed data and/or executed serially such that the output of one MLM 115 is input to another MLM 115. In fact, some MLMs 115 can be executed in parallel using the unprocessed data as input while other MLMs are serial processed with one another in a chain.

For example, two MLMs 115 can be processed in parallel with one another. The first MLM 151 labels the data with transaction types while a second MLM 115 concurrently processes the data and labels the data with entity types. A third MLM 115 uses the labeled output of the first and second MLMs 115 merged together as input data to identify a feature associated with investments or savings transaction types where the entity is a FI which is different from the enterprise of a given customer. The feature labeled by the third MLM 115 can include a geolocation associated with the different MLM 115 in the data. This can permit MLM 116 during training to identify situations in which a given customer is banking with an out-of-state FI, such that MLM 116 can weight this context of labeled features higher than the individual labeled features standing in isolation as evidence of customer planning to leave the enterprise. This is an example of both concurrent processing some MLMs 115 while chaining their labeled output with another MLM 115 for purposes of identifying context features in the data.

Each MLM 115 labels its feature or features within the unprocessed data. When the unprocessed data is finished being processed by the MLMs, an intermediate data set per unique customer of the enterprise is produced as output. Trainer 114 obtains known data about each customer over the period or interval of time being processed. For example, trainer 114 obtains a status indication and status date for the indication from the data stores 123 for purposes of identifying active and inactive status identifiers for each customer and identifying any promotions offered and redeemed by each customer. Any inactive status date is obtained along with promotion offer dates and promotion redemption dates. The status identifiers, offered promotions, and redeemed promotions along with their corresponding dates are labeled as the expected output from attrition MLM 116 within each corresponding intermediate data set.

The intermediate data sets are then segmented or sampled by trainer 114 as first intermediate data sets used for training the attrition MLM 116 and second intermediate data sets used for testing the precision, recall, and F1 values achieved by the MLM 116 on the first intermediate data sets in predicting a first list of customers who left the enterprise and a second list of customers who were going to leave but stayed based on a promotion. When a threshold precision, recall, and F1 values are achieved in the predicted lists of MLM 116, attrition manager 119-1 is notified that the MLM 116 is production ready for running by manager 119-1 on daily intervals of time/any preconfigured recurring interval of time and corresponding data from data stores 125. Trainer 114 also notifies tester 118 that MLM 116 is ready for testing vis-à-vis RFM analyzer 117.

RFM analyzer 117 utilizes an RFM analysis algorithm to analyze customer value and assign an RFM score of 1 to 10 averaged from recency determined values of transactions, frequency determined values of transactions, and monetary values of the transactions associated with the enterprise. Customers who are assigned RFM values below a threshold are assumed to be in progress of leaving the enterprise while customers above the threshold are assumed to be in no danger of leaving. An RFM algorithm is modified to identify the customers with below threshold values as those customers assumed to be predicted to leave the business of the enterprise.

The predicted lists of MLM 116 and the below threshold RFM value customers are then compared against one another by tester 118 along with actual observed customers who left the enterprise and customers who stayed with the enterprise when given an incentive or a promotion based on actual outcomes observed in the data stores of the enterprise. The evaluation metrics can vary by the MLM choice made. Generally, MLMs use but are not limited to precision, recall, and F1 accuracy scores. Precision rates are determined based on the total number customers that left the enterprise versus the number of customers that were predicted to leave the enterprise. Recall rates are determined based on the how many of the predicted customers to leave the enterprise actually left. F1 values are a machine-learning metric that combines the precision and recall rates into an accuracy metric.

In instances where the MLM 116 was incorrect in predicting customers who would leave and incorrect in predicting customers who will not leave if given a promotion, the actual data is saved associated with these customers for a re-training of the MLM 116 during subsequent training sessions. This creates an automated feedback loop to improve the F1 metric of MLM 116. Tester 118 maintains the re-training data and provides to trainer 114 for retraining MLM 116.

On a daily basis or a predefined recurring interval of time, data for the customers from the data sources 125 is acquired over a given interval of time of past time, such as last three months. Each recurring interval of time includes data for the previous day as well as the last day in the given interval of time. For example, if the predefined recurring interval of time is once a day, the current date is Jan. 1, 2023, and given interval of time is two months, the data obtained from data sources 125 includes data beginning on Nov. 1, 2022 and ending with Dec. 31, 2022. The data is processed when received through MLMs 115 (if needed because only the day before in the predefined interval of time was presumably not already processed for labeled features in the intermediate data sets by MLMs 115); at least the previous day's worth of data is processed through MLMs 115.

The labeled intermediate data sets are produced as output and provided to MLM 116, and attrition manager 119-1 obtains the two predicted lists. Manager 119-1 then uses APIs 119-2 to send the predicted lists to one or both of the attrition interface 123 and the promotion system. The enterprise can track the predicted lists on the recurring interval of time, which itself can be set by the enterprise through the attrition interface 123, which interacts with attrition manager 119-1.

FIG. 1B is a flow diagram of a method 100A for operating the system 100 of FIG. 1A, according to an embodiment. At 1, data is obtained from data stores 125. The data is obtained upon request by collector 113 (i.e., pulled/requested by collector 113) at preconfigured intervals of time, Data collector 113 provides the data as input to classification MLMs 115 at 2 and concurrent provides the data as input to RFM analyzer 117 at 3. Featured labeled intermediate data is obtained as output by trainer 114. If trainer 114 has not released attrition MLM 116 for production, then trainer 114 trains MLM 116 as discussed above. Once the F1 metric for MLM is above a threshold, trainer 114 releases MLM 116 for production at 5. During production, output from classification MLMs 115 are streamed as input to attrition MLM 116 at 6.

Attrition MLM 116 generates two predicted list of customers, the first list identifies customers who are predicted to leave the enterprise and the second list identifies customers who are predicted to stay with the enterprise if provided a promotion or an incentive. The predicted lists are received when produced in production by attrition manager 119-1 at 7. Attrition manager 119-1 processes APIs 119-2 at 8 to provide the lists direction to one or both of attrition interfaces 123 and promotion systems 124 at 9 and 10.

Simultaneously and concurrent to the processing of 6-10, a continuous feedback loop is processed at 11-13. That is, production ready MLM 116 provides predicted lists to tester 118 at 11 while simultaneously providing the predicted lists to manager 119-1 at 7. Tester 118 obtains the customer RFM values from RFM analyzer 117 at 12 and compares customers predicted to leave the enterprise against the predicted lists of MLM 116 against customer with RFM values below a threshold in view of known results for the customers of the enterprise. This allows tester 118 to identify customers that were missed by the predicted lists of MLM 116 but identified by RFM analyzer and vice versa and computer precision rates, recall rates, and F1 accuracy metrics for MLM 116. Data that was missed or incorrectly provided by MLM 116 is sent at 13 for re-training MLM 116 during ongoing training sessions conducted by trainer 114. Trainer 114 updates MLM 116 at 5 each time a training session completes.

In an embodiment, the first predicted list includes a first list of customers that are predicted to leave the enterprise regardless as to whether a promotion is provided or not. The second predicted list includes a second list of customer that are not in the first list and are identified with a high likelihood (above a threshold value) of staying with the enterprise if provided a promotion/incentive. So, the customers in the first predicted list do not appear again in the second predicted list.

In an embodiment, the first predicted list includes a first list of customer that are predicted to leave the enterprise and the second predicted list identifies those customers of the first list that have a high likelihood of staying with the enterprise if provided a promotion/incentive.

In an embodiment, the attrition MLM 116 is trained to produce a single list of customer, each customer identifier in the list also includes a likelihood percentage that the corresponding customer stays with the enterprise when provided an incentive. Manager 119-1 determines the customer who will leave and who will stay if given a promotion from the single list of customers and generates two separate lists, which are then provided to interfaces 123 and/or systems 124 using APIs 119-2.

In an embodiment, trainer 114 trains model 116 to uses features associated with cash inflow and outflow historically over a given interval of time instead of features associated with products purchased. In an embodiment, trainer 114 trains model 116 to place a higher weighted value on features associated with high engagement/transaction volume and show a threshold drop in that engagement over the given interval of time.

In an embodiment, model 116 is further trained by trainer 114 to identify predefined events associated with a given customer, such as sudden stop in payments on a mortgage without any indication the customer is selling the home. In an embodiment, the event is associated with the customer signing up for third party entities that compete with the enterprise, such as the banking example presented above.

System 100 is capable of identifying life changing events of customers and identifying dissatisfied customers through feature labeling by MLMs 115 and attrition MLM 116, which an enterprise would otherwise have no way of detecting or would have to rely only on an RFM analysis. The RFM analysis cannot correctly identify customers with life changing events. Life changing events are an excellent indication of customers who are likely to leave or who are susceptible to leaving. These events can include marriage, having children, career change, moving, buying/selling a home, litigation, child custody/support, divorce, death of a loved one, a health condition, etc. The life changing events do not typically happen suddenly and are not explicitly identified in customer data but can be detected and identified when the enterprise uses the predicted list to investigate why the customer is leaving or is dissatisfied with the enterprise to provide reassurance and/or incentives, which can mitigate the changes of the customer leaving the enterprise.

System 100 is capable of identifying those customers that are going to leave the enterprise no matter what the enterprise tries to do through the first predicted list of MLM 116 or through a confidence of percentage value assigned to a customer in a single list by MLM 116. This is of import because wasting resources on customers who have no intention of staying with the enterprise is costly and time consuming and other techniques available in the industry and unable to identify customers not worth trying to retain. As a result, enterprise spend wasted time and resources on these types of customers. Additionally, system 100 is capable of identifying those customers that can be reached out to and retained by the enterprise with a promotion, an incentive, etc. In this way, system 100 is a substantial improvement over what is currently available in the industry to enterprises because it allows the enterprises to proactively focus on customers that can be retained so as to prevent those customers from leaving (attrition) the enterprise.

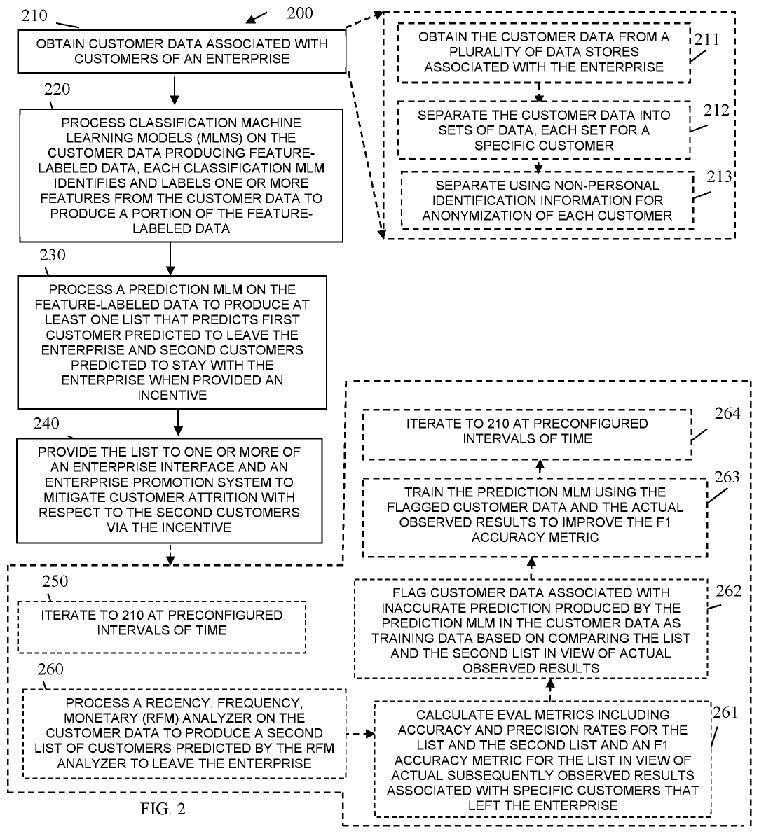

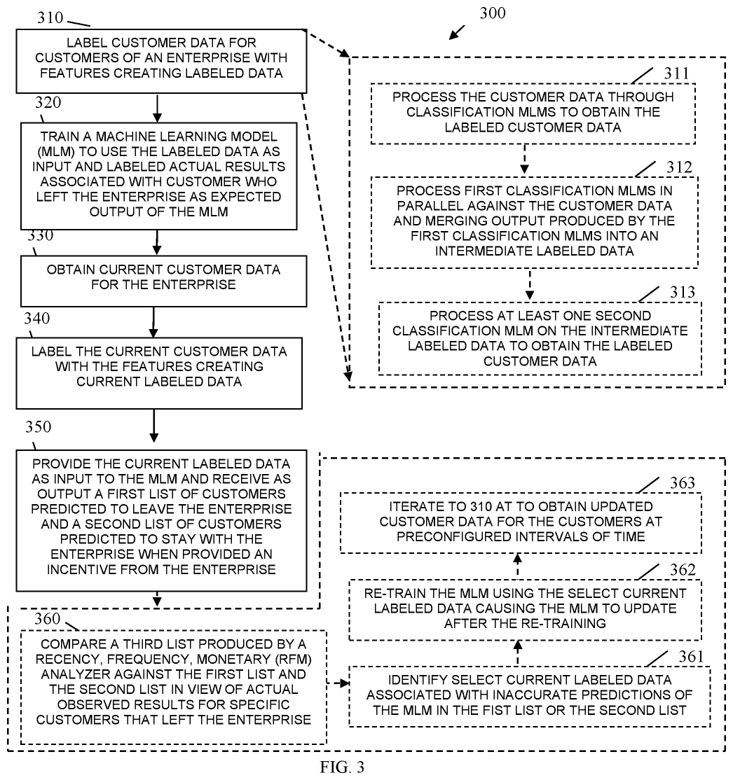

The above-discussed embodiments and other embodiments are now discussed with reference to FIGS. 2-3. FIG. 2 is a flow diagram of a method 200 for predicting and mitigating customer attrition, according to an example embodiment. The software module(s) that implements the method 200 is referred to as an “attrition predictor.” The attrition predictor is implemented as executable instructions programmed and residing within memory and/or a non-transitory computer-readable (processor-readable) storage medium and executed by one or more processors of one or more devices. The processor(s) of the device(s) that executes the attrition predictor are specifically configured and programmed to process the attrition predictor. The attrition predictor has access to one or more network connections during its processing. The connections can be wired, wireless, or a combination of wired and wireless.

In an embodiment, the device that executes attrition predictor is cloud 110. In an embodiment, the device that executes attrition predictor is server 110. In an embodiment, the device that executes attrition predictor is a retail server 120. In an embodiment, the attrition predictor is all of, or some combination of 113, 114, 115, 116, 117, 118, 119-1, and/or 119-2. In an embodiment, the attrition predictor is provided to a retail server 120 and/or a user-operated device as a SaaS integrated via API calls from applications executed on the retail server 120 or the user-operated device.

At 210, the attrition predictor obtains customer data associated with customers of an enterprise from a data store 125 of an enterprise server 120. In an embodiment, at 211, the attrition predictor obtains the customer data from a plurality of data stores 125 associated with the enterprise of the enterprise server 120.

In an embodiment of 211, at 212, the attrition predictor separates the customer data into sets of data. Each set of data is associated with a specific customer. In an embodiment of 212, at 213, the attrition predictor separates the sets of data from the customer data using non-PII for the customers to anonymize each customer and their PII.

At 220, the attrition predictor processes classification MLMs 115 on the customer data to produce feature-labeled data. Each classification MLM 115 identifies and labels one or more features from the customer data to produce a portion of the feature-labeled data.

At 230, the attrition predictor processes a prediction MLM 116 on the feature-labeled data to produce at least one list that predicts first customers predicted to leave the enterprise and second customers predicted to stay with the enterprise when provided an incentive/promotion from the enterprise. In an embodiment, the prediction MLM 116 produces two lists one for customers believed to be unretainable and one for customers believed to be retainable. In an embodiment, the prediction MLM 116 produces a single list with a confidence value or percentage, the percentage associated with a given customer indicates whether the corresponding customer is retainable with a promotion or unretainable based on a threshold confidence value or percentage comparison.

At 240, the attrition predictor provides the list or lists to one or more of an enterprise interface 123 and an enterprise promotion system 124 to mitigate customer attrition with respect to the second customers via an incentive. The list or lists provided via an API 119-2. In an embodiment, the interface 123 includes a dashboard interface where the list or lists are rendered for viewing by an enterprise user.

In an embodiment, at 250, the attrition predictor iterates to 210 at preconfigured intervals of time. This updates the customer date with most recent customer data. In an embodiment, the customer data going back to a configured date from a current date is obtained for the customer data during each iteration.

In an embodiment, at 260, the attrition predictor processes a RFM analyzer 117 on the customer data to produce a second list of customers predicted by the RFM analyzer 117 to leave the enterprise. In an embodiment of 260 and at 261, the attrition predictor calculates evaluation metrics. In an embodiment, the evaluations metrics include accuracy and precision rates for the list and the second list and attrition predictor calculates an F1 accuracy metric for the list (i.e. for the prediction MLM 116 based on the list) in view of actual subsequently observed results associated specific customer that left the enterprise.

In an embodiment of 261 and at 262, the attrition predictor flags customer data associated with inaccurate predictions produced by the prediction MLM 116 in the customer data as training data. This is done based on comparing the list and the second list in view of the actually subsequently observed results.

In an embodiment of 262 and at 263, the attrition predictor calculates trains the prediction MLM 116 using the flagged customer data and the actual observed results to improve the F1 accuracy metric of the MLM 116. In an embodiment of 263 and at 264, the attrition predictor iterates to 210 at preconfigured intervals for time. Thus, a continuous comparison and accuracy check is done on the list or lists predicted by MLM 116 and the MLM 116 is continuously re-trained to improve its F1 accuracy metric.

FIG. 3 is a flow diagram of another method 300 for predicting and mitigating attrition according to an example embodiment. The software module(s) that implements the method 300 is referred to as an “attrition prediction mitigator.” The attrition prediction mitigator is implemented as executable instructions programmed and residing within memory and/or a non-transitory computer-readable (processor-readable) storage medium and executed by one or more processors of one or more devices. The processor(s) of the device(s) that executes the attrition prediction mitigator are specifically configured and programmed to process the attrition prediction mitigator. The attrition prediction mitigator has access to one or more network connections during its processing. The network connections can be wired, wireless, or a combination of wired and wireless.

In an embodiment, the device that executes the attrition prediction mitigator is cloud 110. In an embodiment, the device that executes the attrition prediction mitigator is server 110. In an embodiment, the device that executes the attrition prediction mitigator is retail server 120. In an embodiment, the attrition prediction mitigator is provided to a retail server 120 and/or a user-operated device as a SaaS integrated into applications executing on the server 120 and/or user-operated device via APIs or API calls.

In an embodiment, the attrition prediction mitigator is all of, or some combination of 113, 114, 115, 116, 117, 118, 119-1, 119-2, 123, and/or method 200. The attrition prediction mitigator presents another and, in some ways, enhanced processing perspective from that which was discussed above with the method 200 of the FIG. 2.

At 310, the attrition prediction mitigator labels customer data for customers of an enterprise with features creating labeled data. The labeled data including the features identified in the customer data.

In an embodiment, at 311, the attrition prediction mitigator processes the customer data through classification MLMs 115 to obtain the labeled customer data. In an embodiment of 311 and at 312, the attrition prediction mitigator processes first classification MLMs 115 in parallel against the customer data. The attrition prediction mitigator then merges output produced by the first classification MLMs 115 into an intermediate labeled data. In an embodiment of 312 and at 313, the attrition prediction mitigator processes at least one second classification MLM 115 on the intermediate labeled data to obtain the labeled customer data. The second classification MLM 115 utilizes features labeled in the intermediate data to label additional features that have context based on the intermediate labeled features.

At 320, the attrition prediction mitigator trains a MLM 116 to use the labeled data as input and labeled actual results associated with customer who left the enterprise as the expected output from the MLM 116. Training on additional customer data continues until an acceptable F1 metric is achieved at which point the MLM 116 is production ready and ready for integration with enterprise interfaces 123 and enterprise systems 124.

At 330, the attrition prediction mitigator obtains current customer data for the enterprise. At 340, the attrition prediction mitigator labels the current customer date with the features creating current labeled data.

At 350, the attrition prediction mitigator provides the current labeled data as input to the MLM 116 and receives as output a first list of customers predicted to leave the enterprise and a second list of customers predicted to stay with the enterprise when provided an incentive from the enterprise. In an embodiment, a single list is produced each entry in the list is a customer identifier known only to the enterprise and a confidence value or percentage indicating how likely the corresponding customer is to stay with the enterprise when given a promotion or an incentive. Any confidence value above or below a predefined threshold identifies which customer is not retainable and which customer is retainable with the incentive.

In an embodiment, at 360, the attrition prediction mitigator compares a third list produced by an RFM analyzer 117 against the first list and the second list in view of actual observed results for specific customers that left the enterprise. It is noted that the RFM analyzer 117 can be processed at any time and does not have to follow 350 and can be concurrent with 310 as the RFM analyzer 117 is processed off the raw customer data and does not require the labeled data. The third list provided by the RFM analyzer 117 can sit and be immediately available for processing at 350 when needed by the attrition prediction mitigator.

In an embodiment of 360 and at 361, the attrition prediction mitigator identifies select portions in the current labeled data associated with inaccurate predictions of MLM 116 that are identified in the first list or the second list. In an embodiment of 361 and at 362, the attrition prediction mitigator re-trains the MLM 116 using the select current labeled data causing MLM 116 to update after re-training. In an embodiment of 362 and at 363, the attrition prediction mitigator iterates to 310 at obtain updated customer data for the customer at preconfigured intervals of time. Thus, attrition prediction mitigator is processed continuous as a customer attrition predictor.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
obtaining customer data associated with customers of an enterprise;
processing classification machine-learning models (MLMs) on the customer data producing feature-labeled data, each classification MLM identifies and labels one or more features from the customer data to produce a portion of the featured-labeled data;
processing a prediction MLM on the feature-labeled data to produce at least one list that predicts first customers predicted to leave the enterprise and second customers predicted to stay with enterprise when provided an incentive; and
providing the at least one list to one or more of an enterprise interface and an enterprise promotion system to mitigate customer attrition with respect to the second customers via the incentive.

2. The method of claim 1 further comprising, iterating to the obtaining at preconfigured intervals of time.

3. The method of claim 1 further comprising, processing a Recency, Frequency, Monetary (RFM) analyzer on the customer data to produce a second list of customers predicted by the RFM analyzer to leave the enterprise.

4. The method of claim 3 further comprising, calculating evaluation metrics including accuracy and precision rates for the at least one list and the second list and an F1 accuracy metric for the at least one first list in view of actual subsequently observed results associated with specific customers that left the enterprise.

5. The method of claim 4 further comprising, flagging customer data associated with inaccurate predictions produced by the prediction MLM in the customer data as training data based on comparing the at least one list and the second list in view of the subsequently observed results.

6. The method of claim 5 further comprising, training the prediction MLM using the flagged customer data and the subsequently observed results to improve the F1 accuracy metric of the prediction MLM.

7. The method of claim 6 further comprising, iterating to the obtaining at preconfigured intervals of time.

8. The method of claim 1, wherein obtaining further includes obtaining the customer data from a plurality of data stores associated with the enterprise.

9. The method of claim 8, obtaining further includes separating the customer data into sets of data, each set associated with a specific customer.

10. The method of claim 9, wherein separating further includes separating the customer data into the sets of data using non-personal identification information associated with each customer to anonymize the sets of data associated with the customers.

11. A method, comprising:
labeling customer data for customer of an enterprise with features created labeled data;
training a machine-learning model (MLM) to use the labeled data as input and labeled actual results associated with customers leaving the enterprise as an expected output of the MLM;
obtaining current customer data for the enterprise;
labeling the current customer data with the features creating current labeled data;
providing the current labeled data as input to the MLM and receiving as output a first list of customers predicted to leave the enterprise and a second list of customers predicted to stay with the enterprise when provided an incentive from the enterprise; and
providing the first list and the second list to the enterprise.

12. The method of claim 11 further comprising, comparing a third list produced by a Recency, Frequency, Monetary (RFM) analyzer against the first list and the second list in view of actual observed results for specific customer that left the enterprise.

13. The method of claim 12 further comprising, identifying select current labeled data associated with inaccurate predictions of the MLM in the first list or the second list.

14. The method of claim 13 further comprising, re-training the MLM using the select current labeled data causing the MLM to update after the re-training.

15. The method of claim 14 further comprising, iterating to the labeling of the customer data to obtain updated customer data for the customers of the enterprise at preconfigured intervals of time.

16. The method of claim 11, wherein labeling the customer data further includes processing the customer data through classification MLMs to obtain the labeled customer data.

17. The method of claim 16, wherein processing further includes processing first classification MLMs in parallel against the customer data and merging output produced by the first classification into an intermediate labeled data.

18. The method of claim 17, wherein processing further includes processing at least one second classification MLM on the intermediate labeled data to obtain the labeled customer data.

19. A system, comprising:
a cloud server comprising at least one processor and a non-transitory computer-readable storage medium,
the non-transitory computer-readable storage medium comprising executable instructions,
wherein the executable instructions, when executed by the at least one processor cause the at least one processor to perform operations comprising:
training classification machine learning models (MLMs) to identify features from customer data of customers associated with an enterprise;
merging labeled customer data into intermediate customer data;
training an attrition prediction MLM to take as input the intermediate customer data and produce as output a first list of customers predicted to leave the enterprise and a second list of customers predicted to stay with the enterprise when provided an incentive;
at predefined intervals of time obtaining updated customer data from data stores of the enterprise;
during each interval:
processing the classification MLMs to obtain current labeled feature data;
merging the current labeled featured data into current intermediate customer data;
processing the attrition prediction MLM to obtain a current first list of customers and a currency second list of customers;
using an application programming interface (API) to provide the current first list and the current second list to an enterprise interface and to an enterprise promotion system;
processing a Recency, Frequency, Monetary (RFM) analyzer against the updated customer data and obtaining a third list of customer predicted by the RFM analyzer to leave the enterprise;
comparing current the first list, the current second list, and the third list against actual observed results where specific customers left the enterprise and identifying in the current intermediate customer data portions associated with inaccurate predictions made by the attrition prediction MLM; and
re-training the attrition prediction MLM on the current intermediate customer data portions as a continuous feedback loop to improve an F1 accuracy metric of the attrition prediction MLM in providing the current first list and the current second list.

20. The system of claim 19, wherein the operations associated with the using the API further includes rendering the first list and the second list within a dashboard screen associated with the enterprise interface.
